(19) United States
(12) Patent Application Publication
(10) Pub. No.: US 2006/0290684 A1
(43) Pub. Date: Dec. 28, 2006

(54) Coordinate detection system for a display monitor

(75) Inventors: Andrea Giraldo, Eindhoven (NL); Galileo June Adeva Destura, Eindhoven (NL); Hugo Johan Cornelissen, Eindhoven (NL); Martin Jacobus Johan Jak, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/572,623

(22) PCT Filed: Sep. 15, 2004
(86) PCT No.: PCT/IB04/51769

§ 371 Date: Mar. 17, 2006

(30) Foreign Application Priority Data
Sep. 22, 2003 (EP) 03103492.9

(51) Int. Cl. G09G 5/00

(52) U.S. Cl. 345/175

(57) ABSTRACT

The present invention relates to an apparatus for detecting an input position on a screen of a display monitor. The apparatus comprises a light guiding layer (301) having an optical structure such that a fraction (304) of the light (303) incident on the layer (301) from the apparatus' exterior is confined in the layer (301). The incident light (303) is emitted by a remote input device, operable by a user, for interacting with the apparatus. The remote input device is, for example, a laser pointer (205). Light detecting means (803) in the apparatus detects the light (304) confined in the layer (301). It is thus possible to determine the input position (206) where the light (207) from the input device enters the layer (301).

### FIELD OF THE INVENTION

The present invention relates to a user input apparatus for detecting an input position relative to the apparatus as a result of user interaction with the apparatus. The apparatus preferably comprises a display monitor.

### BACKGROUND ART

To improve the interactivity between users and computers, touch screen displays have been introduced for multimedia information kiosks, educational centers, vending machines, video games, PCs, etc. A touch screen display is a display screen which can be affected by physical contact, allowing a user to interact with the computer by touching icons, pictures, words or other visual objects on the computer screen. Touching, i.e. establishment of physical contact with the screen, is usually done with a finger, a pen to prevent the screen from becoming dirty and stained, or some other appropriate stylus or pointing device.

Sometimes physical contact for providing straight forward interactivity is not the best option, for example when the screen is large and/or when the screen is located at some distance from the user. For example, when giving a presentation, a user interacting with the screen will block the audience's view thereof.

In such cases, the use of a beam of light provided by means of a light source is an attractive option for interaction with the screen. For interactivity purposes, the use of a light source which is visible to the human eye is a more attractive option than using an ordinary IR remote control.

European Patent specification EP 0 572 182 B1 discloses a display unit with integral optical input apparatus. The display unit has a liquid crystal display (LCD) panel comprising conductors in X-axis and Y-axis directions disposed on one of the substrates of the LCD panel. These conductors are optical wave guides for guiding light parallel to the surfaces of the substrates. A light receiving element for sensing an optical signal is disposed in an end portion of each of the optical wave guides.

When light emitted from an optical pen comes into contact with the substrate, X and Y coordinates of the contact portion of the emitted light is determined by the light receiving elements in the form of e.g. photo sensors. A problem with EP 0 572 182 B1 is that the optical wave guides are formed in the substrate, or substrates, of the LCD panel. This makes the display unit difficult and expensive to manufacture, since the processes used for forming the wave guide in the substrate are rather complex. Moreover, the fact that the wave guides are formed in the substrate is prejudicial to the flexibility in manufacture of the display unit, since the wave guides must in practice be formed in the substrate at the time of manufacture and thus cannot be added to the display unit after manufacture of the same.

### SUMMARY OF THE INVENTION

It is an object of the present invention to provide a user input apparatus, preferably combined with a display device, for detecting an input position on a screen of the apparatus, the apparatus being easy to manufacture and the image quality of the display device being affected to an extent as small as possible. Within this context, ‘input position’ should be understood to include a coordinate relative to the apparatus and where user interaction takes place, e.g. where light emitted by an optical pen enters the apparatus.

This object is attained by an apparatus according to claim 1. Preferred embodiments are defined by the dependent claims.

According to an aspect of the invention, a coordinate detection system is provided, in which a light guiding layer is arranged in the apparatus. The layer has an optical structure arranged to confine a fraction of light in the layer when the light is incident on the layer from the apparatus' exterior and to transmit light through the layer when the light is incident on the layer from the apparatus interior. The system has light detecting means arranged to detect the light which is confined in the layer.

The idea of the present invention is that a light guiding layer having certain optical properties is arranged in an apparatus. The layer has an optical structure such that, on the one hand, a fraction of the light incident on the layer from the exterior of the apparatus is confined in the layer and on the other, for light incident on the layer from the interior of the apparatus, the layer appears substantially transparent and almost all the light is transmitted through the layer.

The light originating from the exterior is emitted from a remote input device which is operated by a user for interacting with the apparatus. For example, the remote input device comprises a light pen or a laser pen. The light originating from the apparatus' interior is emitted by the display monitor itself. It is preferred that this light passes through the layer with an attenuation that is as small as possible, in order not to reduce brightness and contrast of the displayed image.

Light detecting means in the form of, e.g., photo detectors arranged in the apparatus, detects the confined portion of the light emitted by the input device. By detecting the light confined in the layer, it is possible to determine the input position (point of incidence) of light impinging on the layer from the input device such as a laser pointer or some other suitable, focused optical pointer means.

The present invention is advantageous, since reliable detection of incident light can be provided in a rather flexible manner. The light guiding layer, having the structure of a foil, a film or the like, is easy to assemble in an apparatus or to integrate with a display monitor, and works for most types of display monitors, such as LCD, CRT, different types of LED technologies, e.g. OLED, PLED, etc. Devices in which the present invention can be applied include mobile phone screens, PDAs, laptops, different types of monitoring devices, television sets, projection screens etc. The layer can be attached to an appropriate substrate in the display monitor by means of adhesive or any other suitable attaching means. Moreover, because of the transparency property, the layer causes only a small transmission loss for light impinging on the layer from the display monitor's interior. Further, the layer has the advantage that it need not be perfectly aligned or registered with the underlying pixels of the display monitor, which facilitates the layer assembling procedure.

According to an embodiment of the invention, canalizing means is arranged in the layer to canalize the light confined in the layer such that the confined light travels in a first direction and a second direction, the directions being parallel to the plane of the layer. The first direction is preferably, but not necessarily, substantially perpendicular to the second direction, such that an X-axis and a Y-axis is defined in the plane of the layer. This is advantageous, since the greater the amount of light that is directed towards the light detecting means, the lower the sensitivity of the light detecting means has to be. Moreover, the coordinate detection will be more accurate if the light beam directed towards the light detecting means is somewhat focused, meaning that a smaller area of the detecting means is exposed to light.

According to another embodiment of the invention, the canalizing means comprises a pyramidally shaped structure arranged in the layer. With a top angle of the pyramidal structure of approximately 90 degrees, this optical structure is capable of capturing a fraction of the light incident on the layer from the apparatus' exterior and canalize it in the first and second direction. By altering the geometrical parameters of the pyramid, the optical performance can be customized. Alternatively, the canalizing means comprises a volume holographic structure having a slanted grating. This optical structure is also capable of capturing a fraction of the light incident on the layer from the apparatus' exterior and canalizing it in the first and second direction. By altering the slant angle and/or the grating pitch of the hologram, the optical properties can be customized.

According to yet another embodiment of the invention, the light detecting means comprises a first light detecting means and a second light detecting means, in the form of, e.g., photo detectors, arranged to detect the light which is confined in the layer and which travels in the first direction and the second direction, respectively. The first light detecting means is arranged at a first edge of the layer and detects the light traveling in the first direction, thereby determining the x-coordinate of the point of incidence of light impinging on the layer from the apparatus' exterior. The second light detecting means is arranged at a second edge, not being opposite to said first edge, of the layer and detects the light traveling in the second direction, thereby determining the y-coordinate of the point of incidence of light impinging on the layer from the apparatus' exterior. This embodiment is advantageous, since arranging the first and second light detecting means along the edges of the layer provides a stand-alone detection unit which can be placed in front of a display monitor.

According to a further embodiment of the invention, the apparatus comprises a display monitor such as an LCD, an LED-type display, an electronic ink display or any other type of active matrix display. The light detecting means is integrated in the active matrix substrate of the display monitor and the apparatus comprises a light coupling means, such as a small, obliquely arranged mirror, arranged to couple light confined in the layer from the layer to the light detecting means integrated in the active matrix substrate. For example, the display monitor comprises an active matrix liquid crystal display (AMLCD) and the light detecting means comprises the thin film transistors (TFTs) of the active matrix substrate.

A characteristic of semi-conducting materials is photo-electricity, which means that a photo-induced current can be generated in a TFT when exposed to light. Therefore, the TFTs in, for example, conventional liquid crystal displays are shielded from any incident light by a light-rejecting layer.

By making an opening in the layer or by replacing the layer with a layer of another material which is opaque to a specified wavelength, the TFTs can now deliberately be made sensitive to external light (of a specified wavelength). This embodiment has the advantage that a smooth, integrated solution can be provided, since the existing TFTs can be used as photo detectors and, thus, there is no need to provide the system with additional photo detectors.

According to another embodiment of the invention, the light guiding layer is arranged on the exterior face of the apparatus' front plate. This has the advantage that the coordinate detection system can be considered a stand-alone system, which does not have to be integrated in the interior of the display monitor. Contrary to prior art coordinate detection systems for display monitors, there is no need to form a part of the detection system in a substrate of the monitor, but the light guiding layer can be attached to the display front plate after manufacturing and distribution of the display monitor. Since integration into existing display systems is possible, time-to-market can be shortened.

According to a preferred embodiment of the invention, a light guide having a light source arranged to emit light into the light guide is arranged at the exterior face of the layer. The optical matching between the light guide and its surroundings is adapted such that the light of the light source is normally confined within the light guide by means of total internal reflection. Physical contact with the screen (e.g., a touch input by the user) perturbs the total internal reflection in the light guide, whereby light is extracted from the light guide and directed towards the layer.

Preferably, the light guide is arranged on the exterior face of the layer such that the light guide is in physical contact with the layer. However, it is possible that some light transmitting medium is arranged between the layer and the light guide. This medium may for instance be a liquid having a refractive index that is lower than the refractive indices of both the light guide and the layer. The light guide is preferably transparent for the light originating from the remote input device.

When a user of the apparatus provides a touch input, the state of total internal reflection will be perturbed, and light will be extracted from the light guide and directed towards the layer. It is then possible to determine the point of contact on the apparatus by determining the point of incidence of light impinging on the layer from the light source via the light guide.

This embodiment is very advantageous, since it enables for the apparatus to detect both optical contact and physical contact with the apparatus. Thus, a user may provide either a touch input or a remote input using a laser pointer or the like, depending on the situation.

According to yet another embodiment of the invention, an optical filter is arranged on the first and the second light detecting means to increase the selectivity for light incident on the respective light detecting means. For monochromatic light, the optical filter enhances the selectivity for the monochromatic light. Selectivity can be required to distinguish the light impinging on the light detectors from ambient light. The light detectors and/or the optical filters should, in case the light source is of the pulsing type, be adapted to handle the pulsing light by means of synchronization with the pulsed light and/or by means of the optical filters being arranged to pass only the bandwidth of interest.

According to yet a further embodiment of the invention, an electrical signal filter is arranged at the light detecting means to increase the selectivity for electrical signals generated by the light detecting means as a result of light impinging on said light detecting means. This has the advantage that the light used to indicate a position on the display can be processed, for example modulated, and subsequently be demodulated at the electrical signal filter.

Further features of, and advantages with, the present invention will become apparent when studying the appended claims and the following description. Those skilled in the art realize that different features of the present invention can be combined to create embodiments other than those described in the following.

### BRIEF DESCRIPTION OF THE DRAWING

The present invention will be described in detail, by way of example and with reference made to the accompanying drawings, in which:

FIG. 1 shows an example of a prior art display device in which the present invention can be applied;

FIG. 2 shows a schematic front view of a display device and a coordinate detection system in accordance with an embodiment of the present invention;

FIG. 3 shows a front view and a side view of the canalizing means in accordance with an embodiment of the present invention;

FIG. 4 shows a front view of a canalizing means in accordance with an alternative embodiment of the present invention;

FIG. 5 shows a schematic view of a part of a display device to which the present invention is applicable;

FIG. 6 shows a side view of a light coupling means arranged to couple light to the active matrix substrate in accordance with an embodiment of the invention;

FIG. 7 shows a front view and a side view of a light guide arranged at the exterior face of the light guiding layer according to an embodiment of the invention; and

FIG. 8 shows a side view of the light guide arranged at the exterior face of the light guiding layer.

### DETAILED EMBODIMENTS

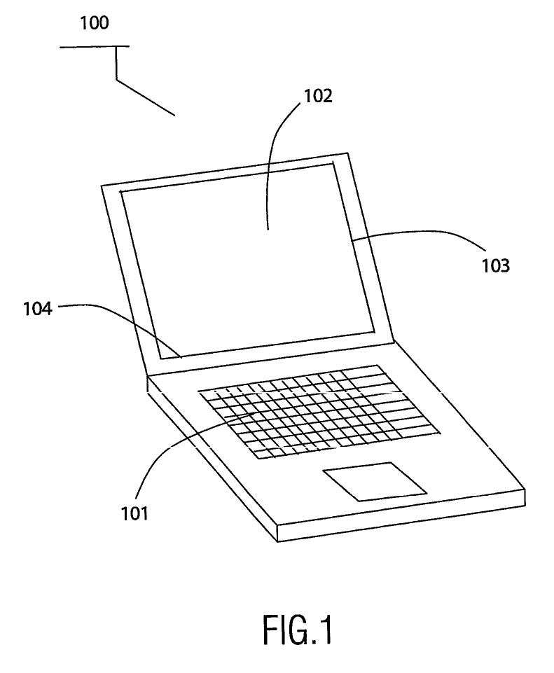

FIG. 1 shows a display device 100 in the form of a laptop arranged with a keyboard 101 and an LCD flat screen 102, in which display device the present invention advantageously can be applied. The coordinate detection system according to the present invention comprising a light guiding layer and light detecting means can be arranged in the display device in a number of different ways, as will be described. For example, the layer can be arranged in the interior of the display device, or preferably, attached to the exterior of the screen. The light detecting means can be arranged at two of the edges 103, 104 of the screen, but can also be arranged in a substrate of the display device, thereby placing the light detecting means in the interior of the display device.

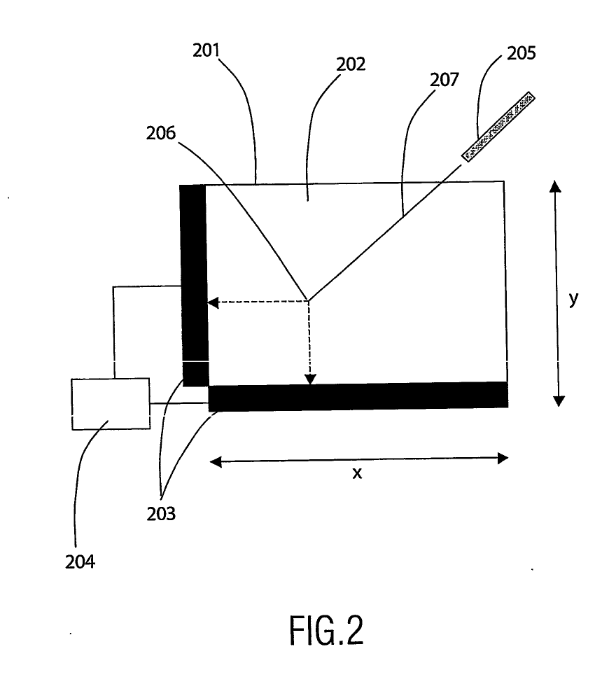

FIG. 2 shows a schematic front view of a display device screen 201, on which a light guiding layer 202 is arranged by means of adhesive. At two of the edges of the layer, light detecting means 203 in the form of e.g. photo detectors are arranged. The light detecting means are connected to a CPU 204 or some other appropriate means having processing capabilities. Typically, the CPU comprises the existing processing means in the device in which the coordinate detection system is applied, the device being for example a laptop, a mobile phone, a projection screen, a television set etc. However, the detection system can be a stand-alone system with its own CPU, which stand-alone system is connected to, and made cooperative with, the device for which coordinate detection is to be applied. A light transmitting device in the form of a laser pen 205 is employed by a user to indicate a point 206 of light on the screen.

The layer has an optical structure such that, for light 207 incident on the layer from the exterior of the display device, a fraction of the light is confined in the layer and canalized in the X and Y directions of the plane of the layer. For light incident on the layer from the interior of the display device, the layer appears transparent and substantially all the light is transmitted through the layer. The light detecting means detect the light which is confined in the layer. By detecting the light confined in the layer, which light is canalized in the X and Y directions, it is possible to determine the point of incidence 206 of light impinging on the layer from the display device exterior, which light is emitted from the laser pen.

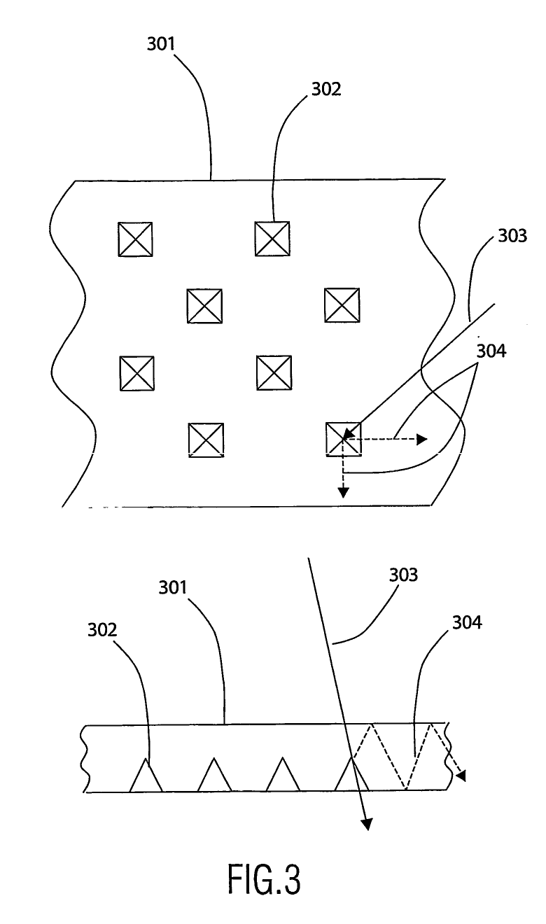

The upper portion of FIG. 3 shows a front view of a part of a light guiding layer 301 arranged with canalizing means in the form of pyramidally shaped, light refracting units 302. The lower portion of FIG. 3 shows a side view of the same layer 301 and the pyramidally shaped canalizing means 302. The canalizing means 302 are arranged in the layer 301 to capture a fraction of the light 303 incident on the layer from the display device exterior and canalize the light confined in the layer such that the confined light 304 travels in a first direction and a second direction, the directions being parallel to the plane of the layer. The first direction is preferably, but not necessarily, perpendicular to the second direction, such that an X-axis and a Y-axis is defined in the plane of the layer. By altering the geometrical parameters of the pyramid, such as the top angle, the base area, the height etc, the optical performance can be customized.

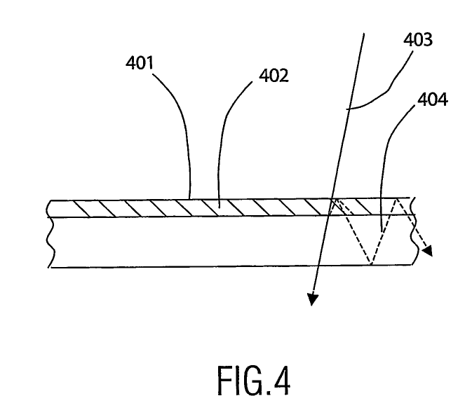

FIG. 4 shows an alternative embodiment of the canalizing means according to the present invention. In FIG. 4, a side view is shown of a light guiding layer 401, wherein the canalizing means 402 consist of a volume holographic structure having a slanted grating. This optical structure is also capable of capturing a fraction of the light 403 incident on the layer from the display device exterior and canalize the light confined in the layer such that the confined light 404 travels in the first and second directions (the X and Y directions). By altering the slant angle and/or the grating pitch of the hologram, the optical properties can be customized.

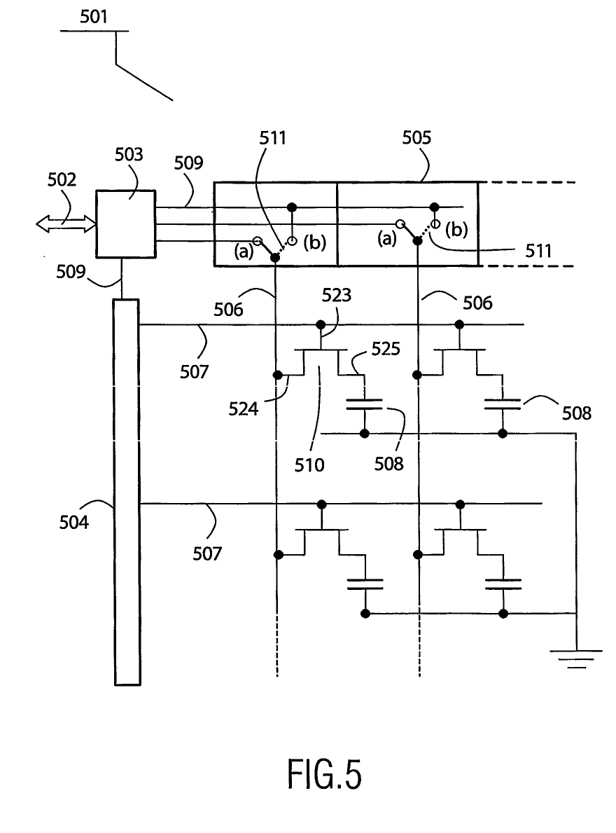

FIG. 5 shows a schematic view of a part of a display device 501 to which the present invention is applicable. It comprises a matrix of elements or pixels 508 at the areas of crossings of row or selection electrodes 507 and column or data electrodes 506. The row electrodes are selected by means of a row driver 504, while the column electrodes are provided with data via a data register 505. To this end, incoming data 502 are first processed, if necessary, in a processor 503. Mutual synchronization between the row driver 504 and the data register 505 occurs via drivelines 509.

Signals from the row driver 504 select the picture electrodes via thin film transistors (TFTs) 510 whose gate electrodes 523 are electrically connected to the row electrodes 507 and the source electrodes 524 are electrically connected to the column electrodes 506. The signal which is present at the column electrode 506 is transferred via the TFT to a picture electrode of a pixel 508 coupled to the drain electrode 525. The other picture electrodes are connected to, for example, one (or more) common counter electrode(s). The data register 505 also contains switches 511 by which either incoming data can be transferred to the column electrodes 506 (situation 511a), or during a sensing stage, the status of TFTs 510 can be sensed (situation 511b of the switches 511).

A characteristic of semi-conducting materials is photo electricity, which means that a photo-induced current is induced in a TFT 510, when the TFT is exposed to light. Therefore, the TFTs in conventional displays are shielded from any incident light by a light-rejecting layer (not shown), such as a black-matrix layer. By making an opening in the light-rejecting layer or by replacing the light-rejecting layer with a layer of another material which is opaque to a specified wavelength, the TFTs can be made sensitive to external light (of a specified wavelength).

A (focused) light beam from e.g. a laser pen may illuminate a TFT 510 locally, and the voltage stored on the capacitor 508 related to the TFT drops on illumination. Sensing of this voltage drop (situation 511b of the switches 511) before writing new information during a next write cycle enables distinguishing between an intentionally illuminated pixel and a non-illuminated pixel. The sensed information is stored in processor 503 and by using dedicated software, the point of incidence of light impinging on the display from the display device exterior can be detected.

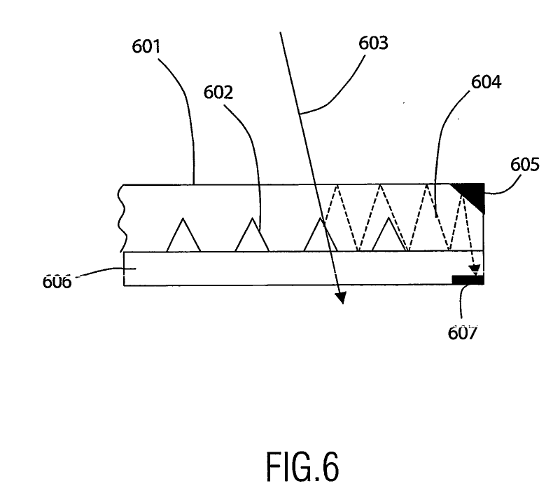

FIG. 6 shows a light coupling means in the form of an obliquely arranged mirror 605. As described earlier, canalizing means 602 are arranged in the light guiding layer 601 to capture a fraction of the light 603 incident on the layer from the display device exterior and canalize the light confined in the layer such that the confined light 604 travels in the previously mentioned first and second directions. The mirror 605 is arranged to couple the confined light 604 to the display 606, which is arranged with an active matrix substrate. For active matrix description, reference is made to FIG. 5. As in FIG. 5, photo detecting means in the form of TFTs 607 are arranged to detect the point of incidence of light impinging on the light guiding layer 601 from the display device exterior. Note that only one TFT 607 is shown in FIG. 6 for reasons of simplicity. In practical applications, one TFT per pixel is used. Using the light coupling means 605, it is only necessary to make openings in the light-rejecting layer (not shown) arranged on the TFT at two of the edges (see FIG. 2) of the display, where light is coupled from the light guiding layer down to the TFTs. Alternatively, if said light-rejecting layer is replaced with an opaque layer of another material, the replacement is only necessary at said two edges.

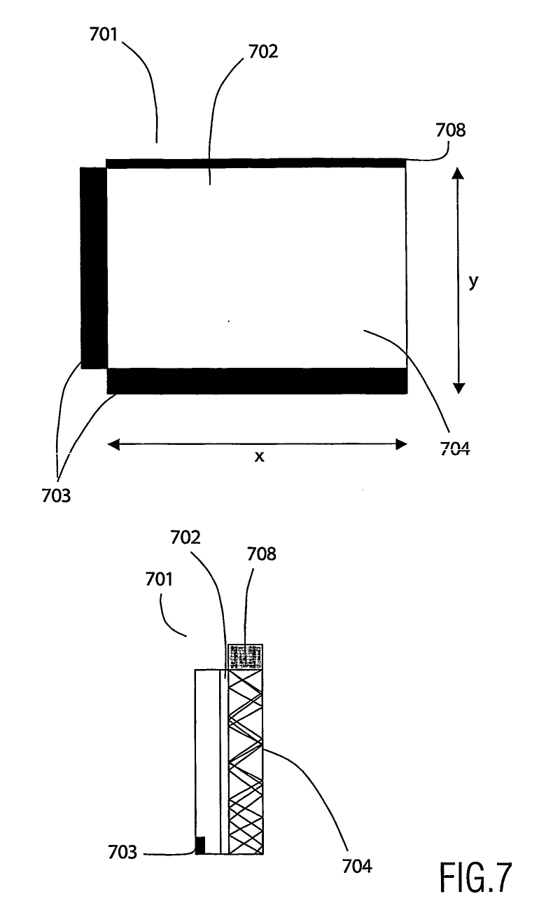

FIG. 7 shows a light guide arranged at the exterior face of the light guiding layer according to an embodiment of the invention. The upper portion of FIG. 7 shows a schematic front view of a display device screen 701, on which a light guiding layer 702 is attached. Light detecting means 703 in the form of TFTs are integrated in the active matrix substrate of the display device to detect incident light. On the light guiding layer 702, a light guide 704 is arranged. The light guide 704 has a light source 708 arranged to emit light into the light guide. The lower portion of FIG. 7 shows a side view of the screen 701. The optical matching between the light guide 704 and its surroundings is adapted such that the light of the light source 708 is confined within the light guide by means of total internal reflection.

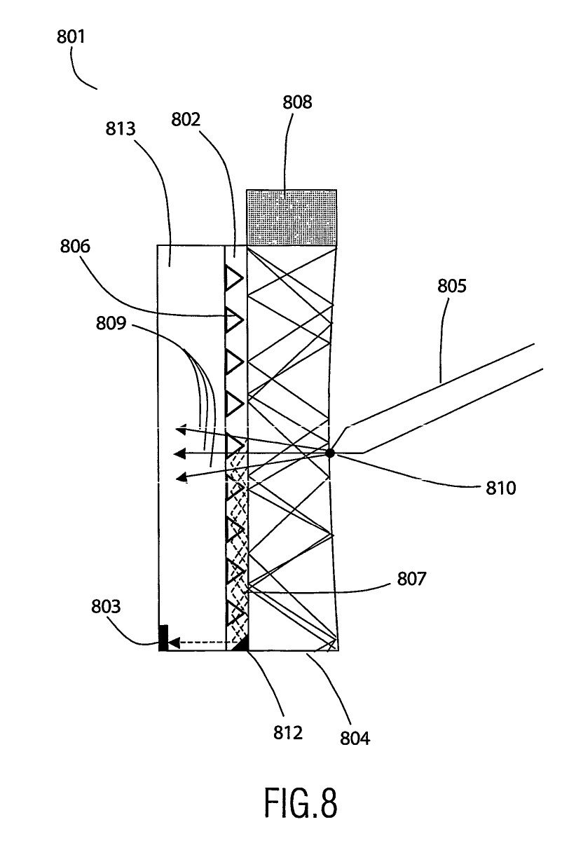

FIG. 8 shows a side view of the screen 801. Physical contact with the light guide 804 by means of, for example, a pen 805 perturbs the total internal reflection, whereby light 809 is extracted from the light guide and directed towards the light guiding layer 802. As in FIG. 2, the layer 802 has pyramidally shaped canalizing means 806 arranged to capture a fraction of the light 809 incident on the layer from the light guide 804 and canalize the light confined in the layer such that the confined light 807 travels in the X and Y directions (the Y direction is shown in FIG. 8), the directions being parallel to the plane of the layer. Preferably, the light guide 804 is arranged on the exterior face of the light guiding layer 802 such that the light guide is in physical contact with the layer. However, it is possible that some light transmitting media is arranged between the layer 802 and the light guide 804. When the state of total internal reflection is perturbed and light is extracted from the light guide 804 and directed towards the layer 802, it is possible to determine the point 810 of contact on the display by determining the point of incidence of light 809 impinging on the layer 802 from the light source 808 via the light guide 804. The light coupling means in the form of a mirror 812 couples the confined light 807 to the display 813, which is arranged with an active matrix substrate. For active matrix description, reference is made to FIG. 5. As in FIG. 5, light detecting means in the form of TFTs 803 are arranged to detect the incident light, and thereby detect the point 810 of contact on the display. Note that at the point 810 of contact, light 809 is scattered in multiple directions. In other words, it can be said that the point 810 of contact acts as a light source which emits the light 809. FIG. 8 shows a simplified view of this scattering which generally occurs in a great number of directions.

This embodiment is very advantageous, since it enables for the system to detect both optical contact and physical contact with the display.

For optical input, the light guide 804 is transparent and detection is effected as previously described, see for example FIG. 2.

Many different alterations, modifications and combinations of the described embodiments will become apparent for those skilled in the art. The described embodiments are therefore not intended to limit the scope of the invention, as defined by the appended claims.

1. A user input apparatus for detecting an input position relative to the apparatus, wherein the apparatus comprises:
a light guiding layer (301), having an optical structure configured to confine a fraction (304) of light (303), incident on the apparatus from the exterior, in the light guiding layer, the incident light (303) being generated by a remote input device operable by a user for interacting with the apparatus, and configured to transmit the confined light (304) through the layer (301) towards light detecting means (303) for detecting the confined light (304) and relating the detecting of the confined light to the input position.

2. The apparatus of claim 1, wherein the light guiding layer (301) comprises canalizing means (302) to canalize the light (304) confined in the layer (301) in a first direction parallel to a plane of said layer (301) and in a second direction parallel to the plane of said layer (301).

3. The apparatus of claim 2, wherein the first direction is substantially orthogonal to the second direction.

4. The apparatus of claim 2, wherein the canalizing means (302) comprises a pyramidally shaped structure.

5. The apparatus of claim 2, wherein the canalizing means (402) comprises a volume holographic structure.

6. The apparatus of claim 1, wherein the light detecting means (203) comprises:
a first light detecting means (203) arranged to detect confined light (304) traveling in a first direction parallel to a plane of said layer (202); and
a second light detecting means (203) arranged to detect confined light (304) traveling in a second direction parallel to the plane of said layer (202).

7. The apparatus of claim 1, comprising a display monitor.

8. The apparatus of claim 7, wherein the display monitor (102) comprises a liquid crystal display, an LED display or an electronic ink display.

9. The apparatus of claim 7, wherein the display monitor (501) comprises an active matrix type display and wherein the light detecting means (607) is integrated with an active matrix substrate (606) of the display, further comprising light coupling means (605) configured to couple at least part of the confined light (604) from said layer (601) to the light detecting means (607).

10. The apparatus of claim 7, wherein the layer (202) is arranged at the exterior face of a screen of the display monitor.

11. The apparatus of claim 1, further comprising:
a light guide (804) arranged at the exterior face of the layer (802) and having a light source (808) arranged to emit light (809) into the light guide (804), the light guide being optically matched with its surroundings in such way that the emitted light (809) is confined within the light guide (804) by means of total internal reflection, and is extracted from the light guide (804) and directed into the layer (802) when a user established physical contact with the apparatus at the input position.

12. The apparatus of claim 1, further comprising an optical filter arranged on the light detecting means (803) to increase the selectivity for light incident on the light detecting means (803).

13. The apparatus of claim 1, further comprising an electrical signal filter arranged at the light detecting means (803) to increase the selectivity for electrical signals generated by the light detecting means (803) as a result of light impinging on said light detecting means (803).

14. The apparatus of claim 1, wherein the light detecting means (803) comprises a photo detector.
